(19) United States
(12) Patent Application Publication
(10) Pub. No.: US 2012/0250667 A1
(43) Pub. Date: Oct. 4, 2012

(54) Phone Terminal, Communication Device, and Terminal Maintenance Method

(76) Inventors: Shinichi Kashimoto, Ome-shi (JP); Shuichi Sato, Sagamihara-shi (JP)

(21) Appl. No.: 13/229,265

(22) Filed: Sep. 9, 2011

(30) Foreign Application Priority Data
Mar. 30, 2011 (JP) 2011-076286

(51) Int. Cl. H04W 8/26; H04W 88/02

(52) U.S. Cl. 370/338

(57) ABSTRACT

According to one embodiment, a phone terminal is connected to a network system. The network system includes a DHCP server. The phone terminal includes a repeater hub, an acquisition module, an assignment module and a communication module. The repeater hub includes a network port connected to the network system, and a port connected to an electronic device. The acquisition module acquires a first IP address for the phone terminal and a second IP address for the electronic device from the DHCP server. The assignment module assigns, in response to an IP address assignment request from the electronic device, the second IP address to the electronic device as a request source. The communication module communicates with the electronic device using the first IP address and the IP address assigned to the electronic device.

### CROSS-REFERENCE TO RELATED APPLICATIONS

This application is based upon and claims the benefit of priority from prior Japanese Patent Application No. 2011-076286, filed Mar. 30, 2011, the entire contents of which are incorporated herein by reference.

### FIELD

Embodiments described herein relate generally to a phone terminal, communication device, and terminal maintenance method for implementing telephone communication using an Internet Protocol (IP) network.

### BACKGROUND

A phone system for transmitting voice packets via an IP network is progressing. This type of system is called Voice over IP (VoIP), and is becoming the mainstream of recent phone systems.

A phone terminal in this type of system is called an IP terminal, and is used by connecting to a network system such as a local area network (LAN). An IP terminal has various functions, and has to undergo maintenance as needed. Operations associated with maintenance include, for example, update of software/firmware associated with the IP terminal, extraction of a call log, and a recovery operation when an error occurs.

To perform maintenance, in many cases, a dedicated personal computer PC is connected to the IP terminal, and operations are performed using the maintenance PC. This imposes the following problems (1) and (2).

(1) The maintenance PC is connected to a network system, and maintenance is performed by accessing, via the network system, the IP terminal to be maintained. In this case, when data is downloaded/uploaded between the maintenance PC and the IP terminal, data packets travel over the network system. The data packet traffic interferes with voice packet traffic, and thus noise occurs in during telephone conversation, thereby degrading the communication quality.

(2) Using the hub function of the IP terminal, the maintenance PC is connected to the port of the hub of the IP terminal to be maintained. In this case, it is necessary to always connect the IP terminal to the network system in order to perform regular refresh of the IP address of the maintenance PC. In maintenance operations, it is desirable to separate the IP terminal from the network system to prevent arrival of a call. In the case of (2) (also in the case of (1)), however, it is impossible to do so.

In maintenance operations for the IP terminal, it is preferable if data traffic does not travel over the network system. It is also desirable to temporarily disconnect a connection between the IP terminal and the network system. There is a need for the development of a system for readily performing maintenance in such an environment without complex settings or system modification.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an example of a phone system according to an embodiment;

FIG. 2 is a functional block diagram showing an example of IP terminals IPT-1 to IPT-4 shown in FIG. 1;

FIG. 3 is a table showing an example of contents managed by a management table 44d;

FIG. 4 is a flowchart illustrating a processing procedure of an IP terminal (IPT) according to the embodiment;

FIG. 5 is a flowchart illustrating a processing procedure of the IP terminal (IPT) according to the embodiment; and

FIG. 6 is a functional block diagram showing an example of a communication device according to the embodiment.

### DETAILED DESCRIPTION

Various embodiments will be described hereinafter with reference to the accompanying drawings.

In general, according to one embodiment, a phone terminal is connected to a network system. The network system includes a DHCP server. The phone terminal includes a repeater hub, an acquisition module, an assignment module and a communication module. The repeater hub includes a network port connected to the network system, and a port connected to an electronic device. The acquisition module acquires a first IP address for the phone terminal and a second IP address for the electronic device from the DHCP server. The assignment module assigns, in response to an IP address assignment request from the electronic device, the second IP address to the electronic device as a request source. The communication module communicates with the electronic device using the first IP address and the IP address assigned to the electronic device.

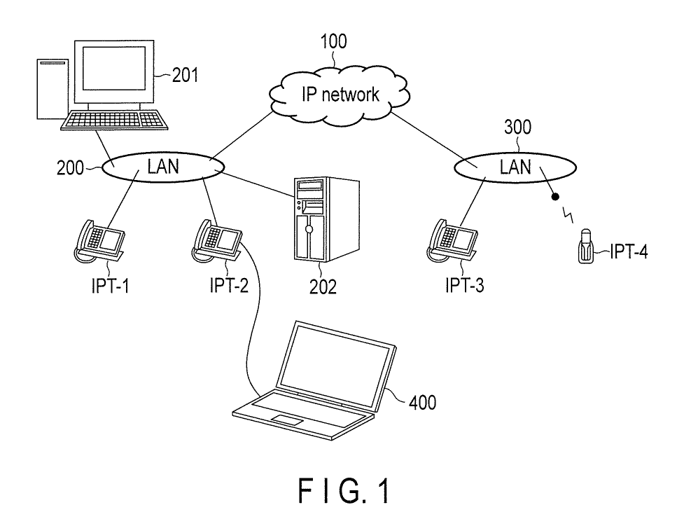

FIG. 1 is an exemplary view showing an example of a phone system according to an embodiment. This example assumes so-called VoIP in which an IP network 100 is used to make a voice call. A call connection processing protocol in the system shown in FIG. 1 is represented by Session Initiation Protocol (SIP). However, the present invention is not limited to this, and a protocol such as Media Gateway Control (Megaco) or H.323 can also be used.

Referring to FIG. 1, a plurality of LANs 200 and 300 are connected to the IP network 100. IP terminals (IPTs) as terminal devices are connected to the LAN 200 or 300. The LAN 200 or 300 is a network system built within a local area like a corporate area.

For example, a Dynamic Host Configuration Protocol (DHCP) server 201 and a SIP server 202 are connected to the LAN 200. The DHCP server 201 serves to execute processing associated with assignment of IP addresses in the IP network (including the LANs 200 and 300). That is, IP terminals IPT-1 and IPT-2 are connected to the network system including the DHCP server. The network system can also cover IP terminals IPT-3 and IPT-4. The SIP server serves to execute processing associated with session creation between clients by peer to peer or via the SIP server.

Each of IP terminals IPT-1 to IPT-4 may be an embedded IP terminal, a mobile communication terminal, or a computer installed with a phone function (a so-called software phone).

In the above configuration, assume that a maintenance PC 400 is connected to IP terminal IPT-2 for maintenance. In this case, to prevent data about maintenance exchanged between IP terminal IPT-2 and the maintenance PC 400 from traveling over the network, it is preferable to disconnect a link between the terminal IPT-2 and the network system (LAN 200). A method of readily implementing this setting will be explained in this embodiment.

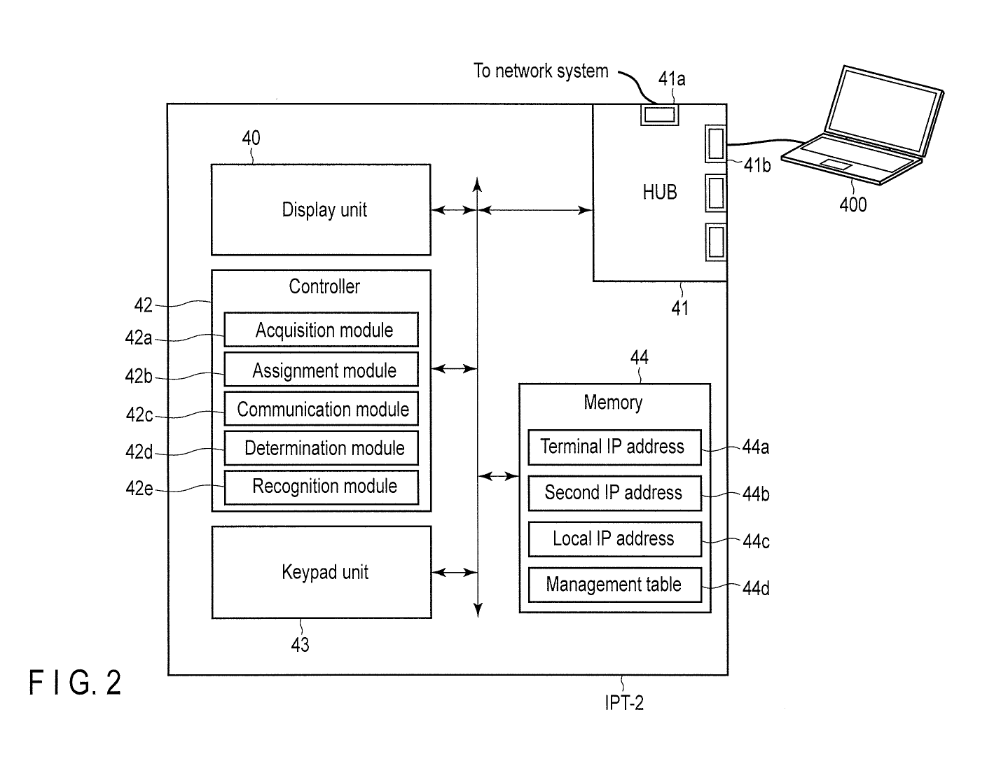

FIG. 2 is a functional block diagram showing an example of the IPT shown in FIG. 1. FIG. 2 shows functional blocks of IP terminal IPT-2. The same applies to other IP terminals IPT-1, IPT-3, and IPT-4.

IP terminal IPT-2 includes a display unit 40, a repeater hub (HUB) 41, a controller 42, a keypad unit 43, and a memory 44. The display unit 40 is, for example, a liquid crystal display (LCD), and visually displays various messages. The keypad unit 43 includes soft keys and numeric keys, and accepts a user input operation.

The repeater hub 41 includes a network port 41a which is connected to a network system via a LAN cable or the like, and a port 41b which is connected to the maintenance PC 400 as an electronic device. That is, the repeater hub 41 has a function (hub function) of transmitting data received from a certain port to another port. This function is implemented by a so-called layer 1 switch, and transparently passes a data packet between ports.

The memory 44 is a rewritable semiconductor storage device such as a flash memory. The memory 44 stores, in its storage area, a terminal IP address 44a, a second IP address 44b, a local IP address 44c, and a management table 44d. The terminal IP address 44a is an IP address for the self terminal (IP terminal IPT-2 in FIG. 2), which has been acquired from the DHCP server 201.

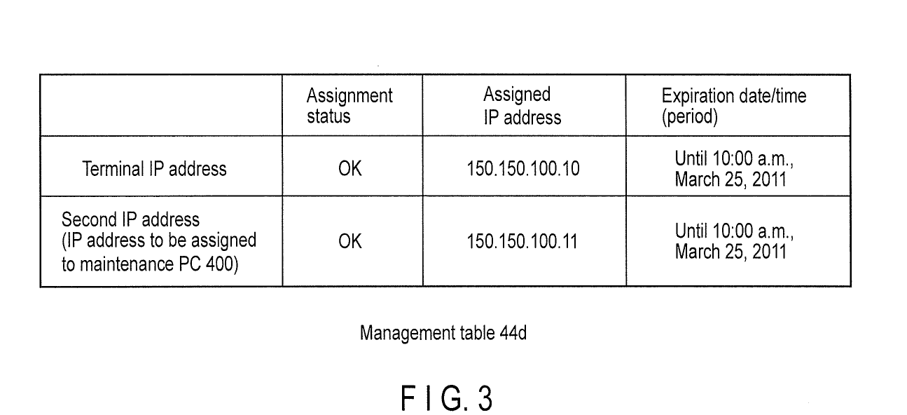

The second IP address 44b is used for communication by the maintenance PC 400 connected via the repeater hub 41. The second IP address 44b is acquired by IP terminal IPT-2 from the DHCP server 201. The local IP address 44c is used for communication between the IPT-2 and the maintenance PC 400. In the above case, the local IP address 44c is assigned to the maintenance PC 400. The management table 44d will be described later with reference to FIG. 3.

The controller 42 includes, as processing functions according to this embodiment, an acquisition module 42a, an assignment module 42b, a communication module 42c, a determination module 42d, and a recognition module 42e.

The acquisition module 42a acquires the terminal IP address 44a and the second IP address from the DHCP server 201, and stores them in the memory 44.

The communication module 42c communicates with the maintenance PC 400 using the terminal IP address and an IP address assigned to the maintenance PC 400. With this communication, for example, data associated with maintenance of the IPT-2 are downloaded/uploaded to the maintenance PC 400. By referring to the contents of the management table 44d in the memory 44, the determination module 42d determines whether it is possible to use the second IP address. If, as a result of this determination process, it is impossible to use the second IP address, the assignment module 42b assigns the local IP address to the maintenance PC 400 as a request source.

The recognition module 42e recognizes a link with a network system via the network port 41a. Simply put, the recognition module 42e can recognize connection/disconnection of a link by, for example, determining whether a LAN cable is connected to the network port 41a.

In response to an IP address assignment request from the maintenance PC 400, the assignment module 42b assigns the second IP address to the maintenance PC 400 as an IP address request source. When the recognition module 42e recognizes that a link is connected, the assignment module 42b stops its own function. It is possible to readily implement such processing by software coding.

FIG. 3 is a table showing an example of contents managed by the management table 44d. As shown in FIG. 3, the management table 44d stores a terminal IP address assignment status (success/failure), the detailed contents of the IP address, and an expiration date/time (period) of the IP address. Similarly, the management table 44d also stores a second IP address assignment status (success/failure), the detailed contents of the IP address, and an expiration date/time of the IP address. That is, the management table 44d is used to manage the success/failure of assignment by the DHCP server 201 and an expiration date/time (lease time limit) for each of the terminal IP address and the second IP address. The influence of the above configuration will be explained next.

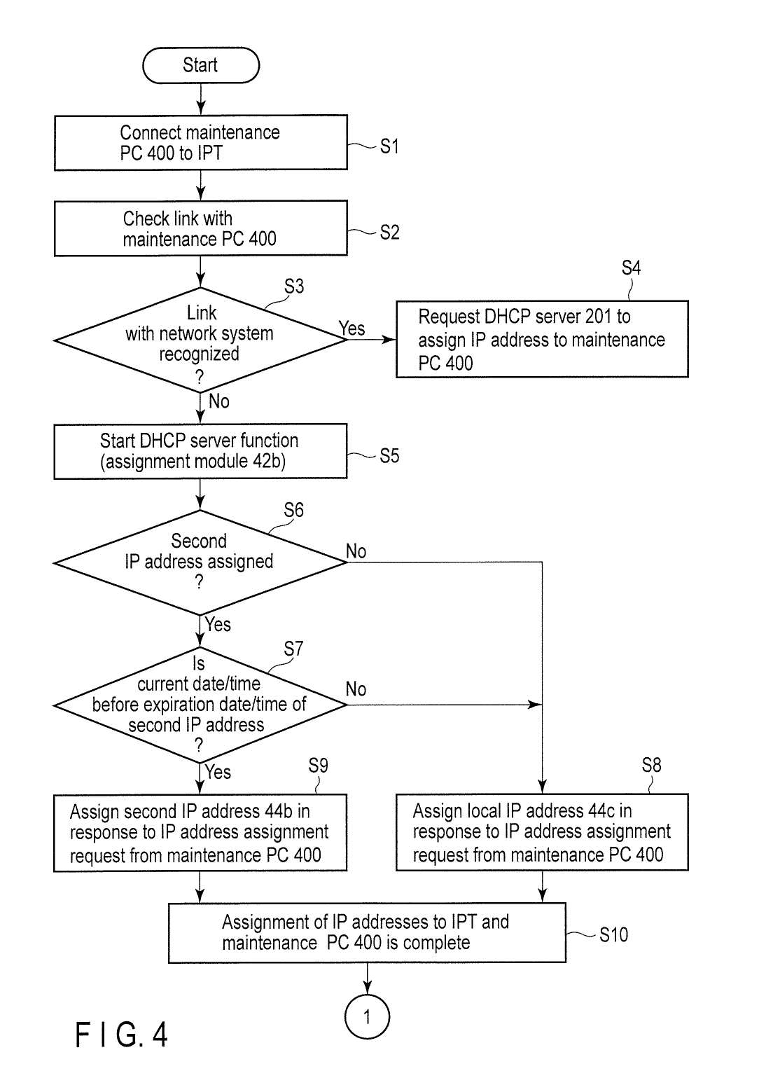

FIG. 4 is a flowchart illustrating a processing procedure of the IP terminal (IPT) according to the embodiment. Assume that the terminal IP address 44a serving as the IP address of the IPT has been already assigned.

Referring to FIG. 4, when the maintenance PC 400 is connected to the IPT (block S1), the IPT checks a link between the IPT and the maintenance PC 400 (block S2). The IPT then recognizes a link between the IPT and a network system (block S3). If the IPT recognizes a link between the IPT and a network system (Yes in block S3), the DHCP server 201 assigns an IP address to the maintenance PC 400 (block S4).

If an IP address is assigned to the maintenance PC 400, the maintenance PC 400 can communicate with the IPT. Note that if the link is recognized, the maintenance PC 400 can also make communication on the network system via the repeater hub 41 of the IPT.

If the IPT does not recognize a link between the IPT and a network system (No in block S3), the IPT starts the assignment module 42b (block S5). With this operation, instead of the DHCP server 201, the assignment module 42b assigns an IP address to the maintenance PC 400.

In this state, upon receiving an IP address assignment request from the maintenance PC 400, the IPT checks whether the DHCP server 201 completes the IP address assignment process. More specifically, the IPT determines whether the DHCP server 201 has assigned the second IP address 44b to the IPT (block S6). If Yes in block S6, the IPT determines whether the current date/time is before the expiration date/time of the assigned second IP address 44b (block S7).

If No in block S6 or S7, the assignment module 42b of the IPT assigns, to the maintenance PC 400, the local IP address 44c to be used between the IPT and the maintenance PC 400 in response to the IP address assignment request from the maintenance PC 400 (block S8).

If Yes in block S7, the assignment module 42b of the IPT assigns the second IP address 44b to the maintenance PC 400 in response to the IP address assignment request from the maintenance PC 400 (block S9).

With the above procedure, a unique IP address is assigned to the maintenance PC 400. This makes it possible to make communication between the IPT and the maintenance PC 400 with the link between the IPT and the network system disconnected, thereby enabling to bi-directionally exchange various data. The various data include log data, backup data, setting data, and file data for program update of the IPT.

Even if the terminal IP address 44a has expired, the static terminal IP address 44a is continuously used until the link with the network system is recognized, that is, until the IPT is reconnected to the network system.

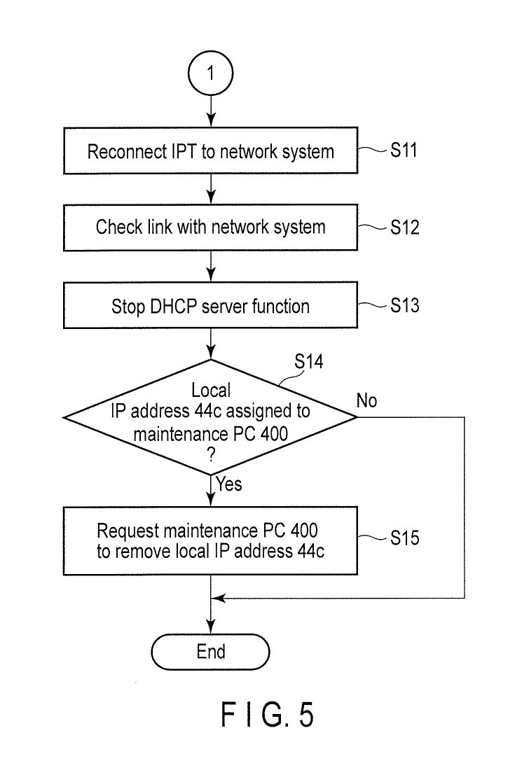

FIG. 5 is a flowchart illustrating a processing procedure of the IP terminal (IPT) according to the embodiment. FIG. 5 shows a processing procedure after an IP address is assigned to the maintenance PC 400 according to the flowchart of FIG. 4 and then the IPT is reconnected to the network system. The processing procedure of FIG. 5, for example, is executed to return the IPT to an operation state after data associated with maintenance are exchanged.

If the IPT is reconnected to the network system (block S11), the IPT recognizes the link between the IPT and the network system (block S12). Then, the IPT stops the function of the assignment module 42b (block S13). The DHCP server function of the IPT is thus stopped.

The IPT determines whether the local IP address 44c has been assigned to the maintenance PC 400 (block S14). If Yes in block S14, the IPT requests the maintenance PC 400 to remove the local IP address 44c (block S15). In response to this, the maintenance PC 400 transmits an IP address assignment request again.

The DHCP server 201 of the network system receives, via the repeater hub 41 of the IPT, the IP address assignment request transmitted from the maintenance PC 400. In response to the IP address assignment request, the DHCP server 201 assigns an IP address. That is, the DHCP server 201 has priority over the assignment module 42b of the IPT with respect to IP address assignment.

If the terminal IP address 44a has expired, the IPT also requests again the DHCP server 201 to assign an IP address after the link with the network system is recognized.

In this embodiment, in addition to the IP address (terminal IP address) of the IPT itself, the IPT requests the DHCP server 201 to assign at least one more IP address (second IP address) to be used by the maintenance PC 400 connected to the IPT. The IPT manages data indicating whether each IP address has been assigned by the DHCP server 201 on the network, and also manages, if the IP address has been assigned, data indicating whether the IP address has expired.

The IPT individually recognizes a link status on the network port 41a and that on the port 41b, and controls IP address assignment to the maintenance PC 400 based on the result of the recognition operation and that of the above management operation.

With the above processing, it is possible to readily make communication between the maintenance PC 400 and the IPT when the maintenance PC 400 is connected to the IPT, and to implement such configuration that data traffic does not travel over the network system. Furthermore, since the IP address assignment function of the IPT is started/stopped according to the presence/absence of the link between the IPT and the network system, it is possible to assign an IP address to the maintenance PC 400 in consideration of the presence of the DHCP server 201. This can prevent the IPT from assigning an IP address to another client. It is, therefore, possible to provide a phone terminal and terminal maintenance method whose maintenance operation is easy.

The present invention is not limited to the above embodiment.

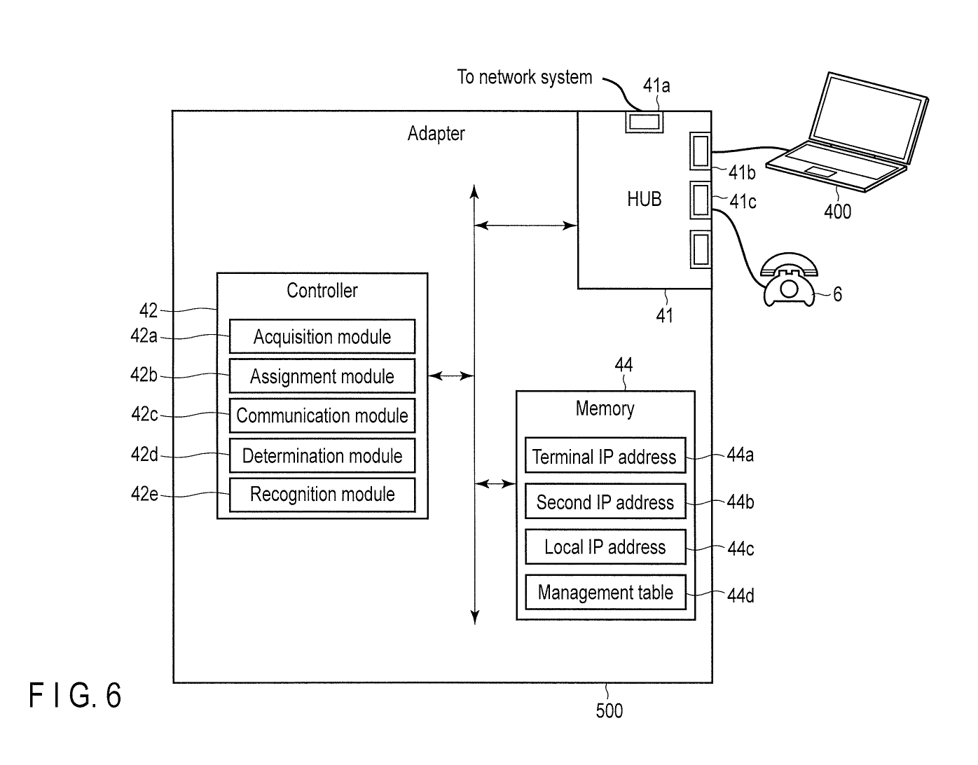

FIG. 6 is a functional block diagram showing an example of a communication device according to the embodiment. FIG. 6 shows an example of a communication device for connecting a standard telephone (to be referred to as a fixed phone denoted by reference numeral 6) having no VoIP function to the network system. This communication device is referred to as an adapter 500.

The adapter 500 provides a VoIP communication function for the fixed phone 6. More specifically, the adapter 500 has a function of accommodating the fixed phone 6, a function of starting a signaling protocol for a phone system by operating the fixed phone 6, a function (incoming call notification function) of generating a ringing tone of the fixed phone 6 by a received signaling message, a function of forwarding voice packets exchanged in the network system to the fixed phone 6, and the like.

The adapter 500 includes the repeater hub 41, controller 42, and memory 44 shown in FIG. 2. In addition to the network port 41a and port 41b, the repeater hub 41 includes a port 41c connected to the fixed phone 6. This configuration makes it possible to provide the communication device whose maintenance operation is easy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A phone terminal which is connected to a network system including a Dynamic Host Configuration Protocol server, comprising:
a repeater hub which includes a network port connected to the network system, and a port connected to an electronic device;
an acquisition module configured to acquire a first Internet Protocol (IP) address for the phone terminal and a second IP address for the electronic device from the Dynamic Host Configuration Protocol server;
a storage module configured to store success/failure of assignment of the second IP address, an expiration period of the second IP address, and a third IP address;
a determination module configured to determine, by referring to stored contents of the storage module, whether it is possible to use the second IP address;
an assignment module configured to assign, in response to an IP address assignment request from the electronic device, the second IP address to the electronic device as a request source and configured to assign the third IP address to the electronic device as a request source if, as a result of the determination process by the determination module, it is impossible to use the second IP address; and
a communication module configured to communicate with the electronic device using the first IP address and the IP address assigned to the electronic device.

2. (canceled)

3. The terminal according to claim 1, further comprising:
a recognition module configured to recognize a link with the network system via the network port,
wherein if the recognition module recognizes the link, the assignment module stops the function of the assignment module.

4. A communication device which is connected to a network system including a Dynamic Host Configuration Protocol server, and connects a phone terminal to the network system, the device comprising:
a repeater hub which includes a network port connected to the network system, a port connected to an electronic device, and a port connected to the phone terminal;
an acquisition module configured to acquire a first Internet Protocol (IP) address for the communication device and a second IP address for the electronic device from the Dynamic Host Configuration Protocol server;
a storage module configured to store success/failure of assignment of the second IP address, an expiration period of the second IP address, and a third IP address;
a determination module configured to determine, by referring to stored contents of the storage module, whether it is possible to use the second IP address;
an assignment module configured to assign, in response to an IP address assignment request from the electronic device, the second IP address to the electronic device as a request source and configured to assign the third IP address to the electronic device as a request source if, as a result of the determination process by the determination module, it is impossible to use the second IP address; and
a communication module configured to communicate with the electronic device using the first IP address and the IP address assigned to the electronic device.

5. (canceled)

6. The device according to claim 4, further comprising:
a recognition module configured to recognize a link with the network system via the network port,
wherein if the recognition module recognizes the link, the assignment module stops its function.

7. A terminal maintenance method of maintaining, by using an electronic device, a phone terminal which is connected to a network system including a Dynamic Host Configuration Protocol server,
wherein the phone terminal comprises a repeater hub including a network port connected to the network system and a port connected to an electronic device, the method comprising:
acquiring, by the phone terminal, a first Internet Protocol (IP) address for the phone terminal and a second IP address for the electronic device from the Dynamic Host Configuration Protocol server;
storing, by the phone terminal, success/failure of assignment of the second IP address, an expiration date/time of the second IP address, and a third IP address in a storage module;
determining, by the phone terminal, whether it is possible to use the second IP address by referring to stored contents of the storage module;
assigning, by the phone terminal, in response to an IP address assignment request from the electronic device, the second IP address to the electronic device as a request source and assigning the third IP address to the electronic device as a request source if, as a result of the determination process, it is impossible to use the second IP address; and
communicating, by the phone terminal, with the electronic device using the first IP address and the IP address assigned to the electronic device.

8. (canceled)

9. The method according to claim 7, further comprising:
recognizing, by the phone terminal, a link with the network system via the network port; and
stopping, by the phone terminal, if the link is recognized, the assigning.
